(19) United States
(12) Patent Application Publication
(10) Pub. No.: US 2010/0121735 A1
(43) Pub. Date: May 13, 2010

(54) AFFILIATE SELLING SYSTEM

(75) Inventor: Yasuyoshi Shimooka, Yachimata-Shi (JP)

Correspondence Address: SUGHRUE MION, PLLC, 2100 PENNSYLVANIA AVENUE, N.W., SUITE 800, WASHINGTON, DC, 20037, US

(73) Assignee: INFOCART, INC., Yachimata-Shi, Chiba (JP)

(21) Appl. No.: 11/996,233

(22) PCT Filed: Jul. 6, 2007
(86) PCT No.: PCT/JP2007/063933

§ 371 Date: Jan. 18, 2008

(51) Int. Cl. G06Q 30/00; G06F 17/30; G06F 15/16

(52) U.S. Cl. 705/27; 707/802; 709/223; 707/E17.044

(57) ABSTRACT

It is an object to provide an affiliate marketing system that automatically guides users to a seller's Web page and does not cause an oversight of a reward payment to an affiliater. A server of an affiliate marketing system is comprised of a guide link generating means that regards an affiliate ID for the identification of an affiliater and a product ID for the identification of a product as an argument URL and that generates URI, information as a guide link in which the argument URL is added to a URL of the affiliate marketing system and the argument URL, and an address converting means that responds to a click operation of the guide link and that carries out an address conversion of an accessed URL of a user terminal device that has done the click operation from the URL of the affiliate marketing system to the URL of the seller's Web page.

### BACKGROUND OF THE INVENTION

1. Field of the Invention

The present invention relates to a computer system for executing affiliate programs.

2. Background Art

In recent years, affiliate programs (also called associate programs) attract attention as a new advertising technique.

The affiliate program is an advertising distribution system of result commission type in which advertising rates are paid to affiliates only after users generate some transactions (product purchase, entry to a questionnaire, member registration, or the like) through browsers. In the affiliate program, administrators of Web sites and mail magazines for individuals and companies display advertiser's (merchant) advertisements on their own sites, and will intend to navigate visitors visited the sites to advertiser's EC (Electronic Commerce) sites. The navigated visitor then goes to the EC site via the advertisement, and when purchases of services and products, member applications, or the like are achieved, the result commissions to navigation source sites are occurred.

In order to execute the affiliate programs, it is necessary to identify, for example, a merchant site browsed by the user, and to implement processing for tracking an information distribution route until the browser finally generates events (product purchase instructions, questionnaire entry, member registration instructions, or the like) relating to transactions. Cookie is utilized for such tracking processing. For example, there are disclosed documents in which tracking information (URL of affiliate ID) is incorporated into a URL for linking and navigating to a seller's site, and calculations of a contingent fee for the affiliate and the like are performed using the information (refer to for example, Japanese Unexamined Patent Application Publication (Kokai) No. 2006-113884).

### SUMMARY OF THE INVENTION

Although the tracking technology using the aforementioned cookie is effective when a user terminal is PC, it cannot be used in a user terminal, such as a portable telephone, that cannot use the cookie as an information storage destination. At present when the portable telephone in which the browser is install has become widely used, the advent of the affiliate programs for the users of browser phones has been desired.

Additionally, as for a system in which functions of the affiliate programs are installed (hereinafter called “affiliate selling system”), it is a principle that a link for affiliate navigation or the like has a unique function for every product. In the conventional affiliate selling system, there has been no problem of lack of payment of commission in normal product sales processing, but when a publisher sells a plurality of products, for example, even though it has navigated to a seller's (publisher's) site by a link for navigation of a product A, if a buyer's mind has changed to thereby purchase a product B, payment of the commission to an affiliate (introducer) has not been effected, resulting in an ineffective commission. This is because contents recorded by the cookie are combinations of a product designation code and an affiliate ID, and it lies in the ability not to identify an association with the seller.

Further, in the conventional affiliate selling system, a system for paying the commission based on sale or introduction counts such as hit counter has been standard, and it has not been provided with a mechanism of accounting and settlement. For that reason, it has been inefficient such that a bill has been manually formed to pay the commission, so that there has also been a fear that an input mistake or the like might occur.

The present invention is made from the aforementioned situations, and an object of the present invention is to provide an affiliate selling system, which makes it possible to automatically navigate the user to a seller's Web page, and does not cause lack of payment of the commission to the affiliate. Another object of the present invention is to provide an affiliate selling system, capable of navigating to the aforementioned seller's Web page and also capable of automatic settlement of the commission to be paid to the affiliate.

The present invention relates to a computer system for executing affiliate programs, and the aforementioned objects of the present invention are achieved by an affiliate selling system provided with a server having a function for navigating to a seller page which is a seller's Web page of products based on a link for navigation pasted on a page of the products introduced on a mail magazine or a weblog by an affiliate, wherein the server includes navigation link creating means for creating, using an affiliate ID for identifying the affiliate and a product ID for identifying the product as an argument URL, URL information in which the argument URL is added to a URL of the affiliate selling system as a link for navigation; and address translation means for address-translating, in response to a click operation of the link for navigation, an access destination URL of a user terminal of the operation source from the URL of the affiliate selling system to a URL of the seller page.

Further, the aforementioned objects of the present invention are more effectively achieved, respectively, by: the navigation link creating means for creating the link for navigation while including the URL of the vendor page in the argument URL; the address translation means for acquiring the argument URL within the, link for navigation and also acquires the URL of the vendor page included in the argument URL, and performing the address translation processing based on the URL; comprising a product information database in which product information including descriptions of products for sale and the URL of the seller page is stored; the address translation means for acquiring, when the URL of the seller page does not exist within the link for navigation, the URL of the seller page, which is stored in association with the product ID or a seller ID for identifying a seller, from the product information database, and performing the address translation processing based on the URL; the server further including means for setting, in response to a click operation of the link for navigation which is displayed on a screen of a user terminal, a cookie on which the product ID or the seller ID for identifying the seller, and the affiliate ID are recorded to the user terminal; the server further including means for analyzing session information between the server and a user terminal to check whether or not the affiliate ID exists, and then acquiring the affiliate ID from the session information if it is determined that the affiliate ID exists, or reading the contents of the cookie to acquire the affiliate ID from the cookie when it is determined that the affiliate ID does not exist; the server further including means for storing, in response to a click operation of the link for navigation which is displayed on a screen of a user terminal, information in which the product ID or the vendor ID for identifying the vendor, and the affiliate ID are recorded in an information storage medium; and the server further including settlement means for automatically determining commission to be paid to the affiliate to automatically transfer it to an account of the affiliate.

### ADVANTAGES OF THE INVENTION

According to the present invention, it becomes possible to once navigate the user to the seller's Web page automatically by the user only clicking on the screen the link for navigation pasted on the page of the products. With this navigation, it is possible to make up for lack of information at the time of displaying in the normal shopping site, and achieve effects of encouraging the willingness to buy. Moreover, since the affiliate ID is included in the link for navigation, the affiliate ID can be obtained from the link for navigation, thus making it possible to achieve the affiliate system without lack of payment of the commission to the affiliates. Further, providing with the settlement means for automatically transferring the commission to the affiliate account makes it possible to reduce inefficient operations such that the bill is manually formed to pay the commission, and to prevent fraudulent acts due to input mistakes of the commission or the like, or falsification of input data.

### BRIEF DESCRIPTION OF THE DRAWINGS

FIG. 1 is a schematic diagram illustrating a configuration of an affiliate selling system in accordance with the present invention;

FIG. 2 is a flow chart for describing registration processing of seller information in accordance with the present invention;

FIG. 3 is a schematic diagram illustrating an example of a product information registration screen in the present invention;

FIG. 4 is a schematic diagram for describing affiliate sales processing in accordance with the present invention;

FIG. 5 is a flow chart for describing acquisition processing of an affiliate ID in accordance with the present invention;

FIG. 6 is a flow chart for describing address translation processing in accordance with the present invention;

FIG. 7 is a schematic diagram illustrating an example of a screen change in a first purchase pattern of products in the present invention;

FIG. 8 is a schematic diagram illustrating an example of a screen change in a second purchase pattern of products in the present invention;

FIG. 9 is a partial view of FIG. 8;

FIG. 10 is a schematic diagram illustrating an example of a screen change in a third purchase pattern of products in the present invention; and

FIG. 11 is a partial view of FIG. 10.

### DESCRIPTION OF SYMBOLS

1: Seller

2: Affiliate (introducer)

3: Purchaser

11a, 11b, 11c: Client (communication terminal)

20: Web server on which seller's page is posted

30: Affiliate selling system

41: Seller information database

42: Affiliate information database

43: Product information database

44: Purchaser information database

### DESCRIPTION OF THE PREFERRED EMBODIMENTS

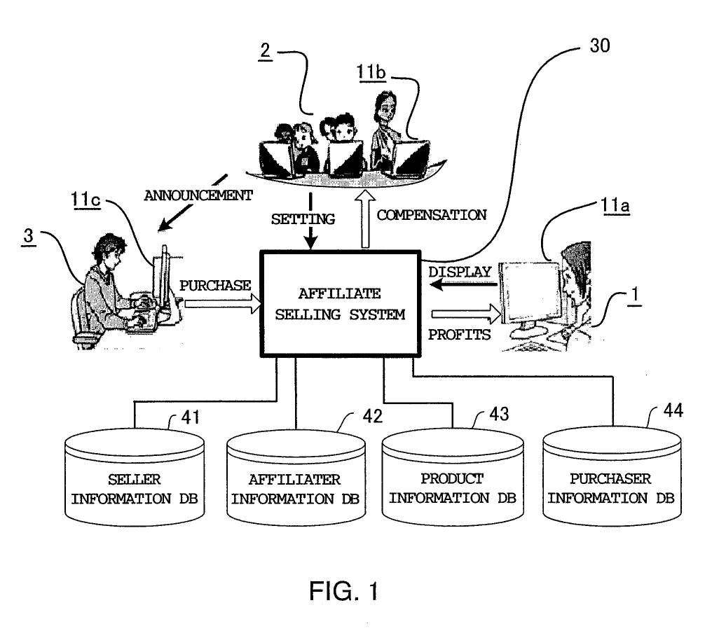

FIG. 1 is a schematic diagram showing a configuration of an affiliate selling system in accordance with the present invention.

An affiliate selling (commerce) system 30 shown in FIG. 1 is an information processing system that ASP (Affiliate Service Provider) administrates, and is a computer system for performing all the processing relating to affiliate services including accounting and settlement systems for commission fees. The affiliate selling system 30 is provided with a plurality of computers, such as a Web server, a database server, a server for settlement processing, a server for administration, or the like, in order to execute affiliate programs, and databases. The database server in the affiliate selling system 30 is provided with a seller information database 41 for storing information on sellers 1 (also called publishers or product suppliers) of products, an affiliate information database 42 for storing information on affiliates (introducers) 2, a product information database 43 for storing information on products for sale, and a purchaser information database 44 for storing information on purchasers 3, as major databases (DB), as shown in FIG. 1. A communication terminal 11a of the seller 1, a communication terminal 11b of the affiliate 2, and a communication terminal 11c of the purchaser 3 are user terminals which install browsers, respectively, and each of the user terminals and the affiliate selling system 30 are communicatably connected with each other through communication networks, such as the Internet. As for each of the communication terminals 11a through 11c, any information processing apparatus, such as a personal computer (PC), a portable telephone, and a PDA (Personal Digital Assistants) which has an Internet connection function can be used.

Incidentally, programs and control data for causing the computer to execute information processing relating to affiliate sales are stored in an external storage media, and also stored in memory means of the computer in the affiliate selling system 30.

The seller 1, the affiliate 2, and the purchaser 3 will be now described.

The “seller” described in the present embodiment refers to a person who sells electronic commerce materials and provides products for the purchasers (product supplier, such as a publisher, a provider of the products). As for the information on the seller 1, user information, such as names and addresses of the sellers 1, is registered into the seller information database 41 in order to receive services that the affiliate selling system 30 has.

The “affiliate” refers to a person who earns the sales margin to be given thereto by introducing and selling products of the product publisher on its own site (introducer). As for the information on the affiliate 2, user information, such as names and addresses of the affiliates 2, is registered into the affiliate information database 42 in order to receive services that the affiliate selling system 30 provides.

The “purchaser” refers to a person who purchases displayed products or the like. As for the information on the purchaser 3, user information, such as names and addresses of the purchasers 3, is registered into the purchaser information database 44 in order to receive product deliveries and service provisions from the seller 1 (product supplier) in the affiliate selling system 30.

In such a configuration, accounting processing and settlement processing in the affiliate selling system 30 will be described first.

The affiliate selling system 30 in accordance with the present invention is provided with accounting means for performing the accounting processing when the purchaser 3 purchases a product, and money for the product that the purchaser 3 has purchased is once altogether deposited in an account of an administration company of the affiliate selling system 30. In the affiliate selling system 30, after writing off an amount of transfer money of introduction commission to the affiliate 2 and deducting a usage fee of this system from the money amount of the sales payment to the seller 1, the money for the product is intended to be automatically transferred into the account of the seller 1. Similarly, the commission thereof is intended to be paid also to the affiliate 2 by automatically transferring the money amount into an account of the affiliate 2.

As information processing means in accordance with payment processing of those commissions, the affiliate selling system 30 is provided with means for automatically determining the commission to be paid to the affiliate 2 (and money amount paid to the seller 1) based on accounting information accumulated and stored in the database by the accounting means and pieces of user information registered into the databases 41 and 42, means for creating settlement data based on information on the determined commission (and the money amount of the product), and means for starting a batch processing program based on, for example schedule information, to automatically execute the settlement processing between the system and computers of the financial institutions based on the settlement data.

The aforementioned payment processing of the commission is executed by the server for settlement processing in the affiliate selling system 30. For example, assuming that there are sales generated in January, the commission for the sales generated in January is paid to the seller 1 on, for example February 25, and an affiliate commission (the commission differs in amount depending on the sellers 1) is paid to the affiliate 2 from the sales of the seller 1 at the end of February. Note herein that pay-by-card and bank transfer are selectable as a form of the settlement.

Next, the affiliate sales processing using an address translation will be described.

A mechanism of the affiliate sales that the affiliate selling system 30 of the present invention has is that a link pasted on a mail magazine or the like link navigates users to a Web site of the seller 1 by the address translation means to make them purchase through a purchase link pasted thereon.

In the present embodiment, as link information (hereinafter, referred to as “affili-link” or “link for navigation”) for link navigation to the Web site of the seller 1, it is provided with means for creating URL information (hereinafter, referred to as “navigation link creating means”) in which an ID (hereinafter, referred to as “affiliate ID”) for identifying the affiliate 2, a URL of the seller page (Web page of the seller 1), and a product ID for identifying the product are added to a URL of the affiliate selling system 30 as an argument (referred to as “argument URL”).

In the navigation link creating means, assuming that, for example, a domain name of a Web site server of the affiliate selling system 30 is “WWW.xyz.JP”; the affiliate ID, “abc”; the URL of the seller page, “def.JP/ghi.html”: and the product ID, “nnn”, following affili-links will be created. In other words, the navigation link creating means creates the link information in which (a1) the affiliate ID, (a2) the URL of the seller page, and (a3) the product ID are added to a low order position of the URL of the affiliate selling system 30 as an argument.

### <An Example of the Affili-Link (Link for Navigation)>

http://www.xyz.jp/af.php?af=abc&url=def.jp/ghi.html&item=nnn

In the present example, it is set that a string of codes attached behind “af=” is the affiliate ID that is the introducer, a URL attached behind “url=” is the URL of the seller page, and information attached behind “item=” is the product ID (unique number in the system).

When the user is navigated by this affili-link, the affiliate selling system 30 sets a cookie in which the product ID (or the ID of the seller 1), and the ID of the affiliate 2 to the communication terminal 11c of a prospective buyer. In other words, it is provided with means for setting, in response to a click operation of the link for navigation on the screen by the purchaser 3, the cookie on which the product ID or the seller ID, and the affiliate ID are recorded to the purchaser terminal 11c. As a result of this, the cookie can maintain that who the introducer of the product has been for a period of validity of a days (for example, a=30).

For that reason, when the prospective buyer adds the URL address (URL address incorporating the affili-link therein) to a “bookmark” of the browser at this stage, even though the prospective purchaser purchases a product (product identified by the product ID) afterwards, it will be fixed that who the introducer (affiliate 2) of the product is as long as it is within the period of validity of a days.

As shown in the following examples, a link (referred to as the “purchase link”) of the product ID “nnn” is set to the seller page, so that the product may be purchased by this mechanism.

### <An Example of the Purchase Link>

www.xyz.jp/a.php?item=nnn

In this example, it is the product ID which is attached behind “item=.” The affiliate ID that is the introducer is not described here. The reason is that the affiliate ID is stored and maintained by the cookie or a session, and the affiliate ID functions by being reconstructed behind the used.

A mechanism including this URL address translation is the greatest feature of the affiliate selling system in accordance with the present invention.

Hereinafter, showing concrete embodiments, processing of the affiliate selling system 30 in accordance with the aforementioned address translation will be described. Note herein that the description including the registration processing of required information will be sequentially made, and an operation example of the whole address translation in accordance with system shall be described later.

### <<1. Registration Processing of Seller Information>>

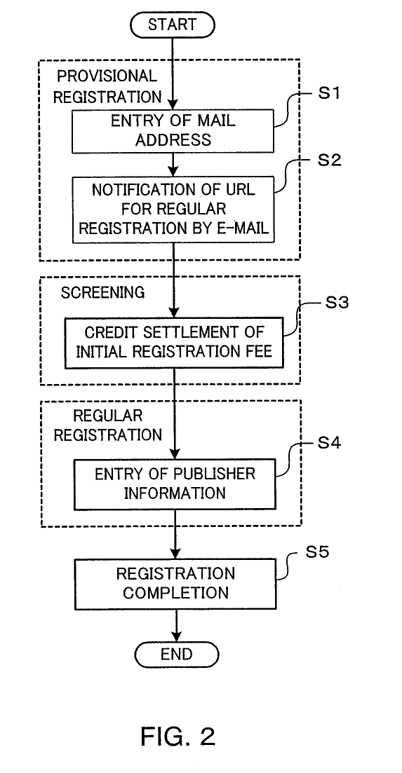

FIG. 2 is a flow chart showing a flow of the registration processing of seller information, and the registration processing of the information on the seller 1 will be described along with the flow of this diagram.

The seller 1 accesses the Web server in the affiliate selling system 30 from the communication terminal 11a, such as a PC or the like, and clicks a register menu of the seller information in the Web page. The affiliate selling system 30 displays a seller's provisional registration screen on a display unit on a side of the communication terminal 11a. An entry field of a mail address is provided in the seller's provisional registration screen, and an entry of the e-mail address is first prompted for the seller 1 (Step S1). The Web server which has received data of the mail address notifies a URL for regular registration by e-mail, and acceptance processing of the provisional registration will be completed (Step S2).

The Web server accessed by the URL for regular registration from the communication terminal 11a displays a regular registration screen on the display unit on the side of the communication terminal 11a, the user then inputs information on a credit card (a card number, an expiration date), and information on an initial registration fee, and the Web server executes credit settlement processing of the initial registration fee. In this embodiment, if the credit settlement is normally completed, it is determined that the seller 1 meets screening criteria (Step S3), and regular registration processing of the seller 1 is executed. Entry fields of the seller information (name, address, telephone number, password, bank account information, seller ID, and the like of the seller 1) are provided in the regular registration screen of the seller 1, the Web server receives the seller information to register it with the purchaser information database 44 retrievably by the seller ID or the like (Step S4), and the registration processing of the seller information will be completed (Step S5). The registration of the seller information here mainly aims at accumulating the seller information based on the law, and transfer information on sales. Incidentally, although the seller is called the “publisher” in the site of the affiliate selling system 30, it is referred to as the “seller” in this embodiment.

### <<2. Registration Processing of Affiliate Information>>

Next, registration processing of the information on the affiliate 2 will be described. Note that since operations in accordance with the registration processing of the information are similar to those of the registration processing of the seller information, it will be simply described hereinafter.

The affiliate information (name, address, telephone number, secret key (password), bank account information, affiliate ID of the affiliate 2, or the like) is provided in an information registration screen displayed on a display unit of the communication terminal 11b of the affiliate 2, and the Web server receives the affiliate information to register it with the affiliate information database 42 retrievably by the affiliate ID or the like. The affiliate ID becomes an introduction ID in sale.

### <<3. Registration Processing of Product Information>>

Next, registration processing of information on products that the seller 1 publishes (displays) will be described.

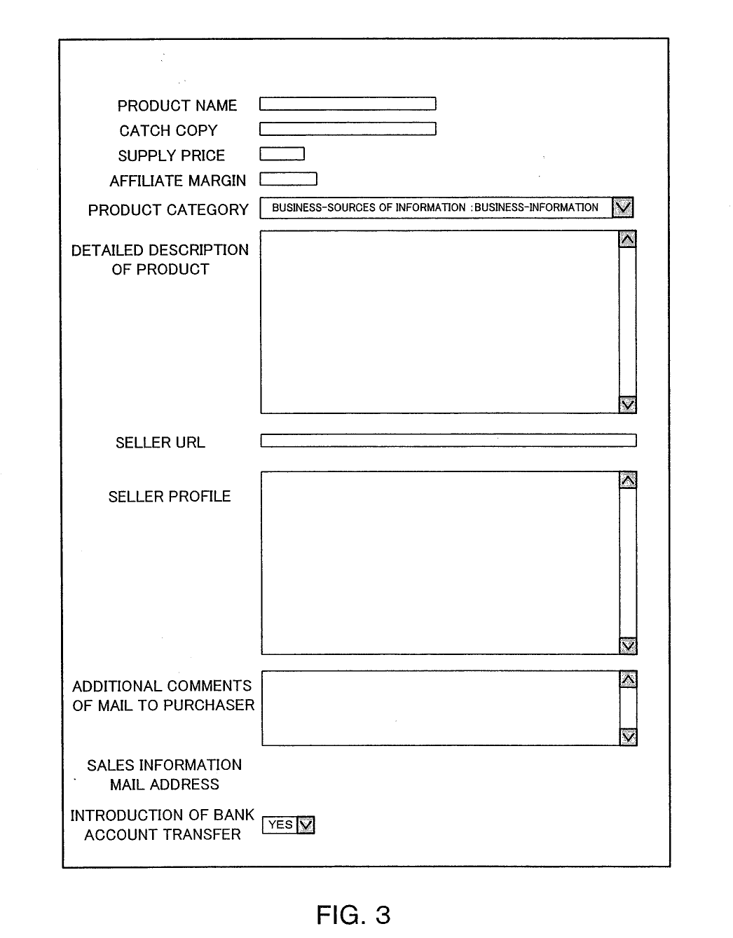

FIG. 3 shows an example of a product information registration screen displayed on the display unit of the communication terminal 11a of the seller 1. Entry fields of a product name, a supply price, descriptions of the product, a URL of the seller page, and photographs of the product (next screen of FIG. 3: the figure is omitted) and the like are provided in the product information registration screen, and the seller 1 inputs the screen information on a product that the seller desires to sell. The Web server receives the product information, automatically gives the product ID thereto (in this example, the product number nnn unique to the system is employed), and registers it with the product information database 43 retrievably by the product ID, the seller ID for identifying the seller, or the like.

### <<4. Creation Processing of Affiliate Link>>

Next, creation processing of the affiliate link (the aforementioned affili-link) for navigating to the web page of the seller 1 will be described.

First, the affiliate 2 that has registered the aforementioned affiliate information accesses the affiliate selling system 30 from the communication terminal 11b if the affiliate 2 desires to introduce products on its own site. The affiliate selling system 30 displays, after authenticating the affiliate 2 by the check of the login ID and the password, a screen of a product list that indicates a list of products on the display unit of the communication terminal 11b. The affiliate 2 navigates a purchaser by choosing a favorite product out of the product list and pasting a following affili-link created by the aforementioned navigation link creating means on its own weblog and mail magazine. Note that a description of a first example shown below will be omitted here since it has the same configuration as that of the example of the aforementioned affili-link.

### <First Example of Affili-Link (Link for Navigation)>

http://www.xyz.jp/af.php?af=abc&url=def.jp/ghi.html&item=nnn

(information after af= is the affiliate ID, information after url= is the URL of the seller page, and information after item= is the product ID)

For example, when the purchaser 3 (purchase applicant) clicks the aforementioned affili-link on the Web screen of the weblog of the affiliate 2, the purchaser 3 moves to the URL of the seller page (in this example “def.JP/ghi.html”) which is a link destination, via the affiliate selling system 30 which is a first access destination, and information on the product corresponding to the product ID “nnn” is displayed on a display unit of the communication terminal 11c of the purchaser 3. At that time, the affiliate selling system 30 extracts information on the product (the product identified by ID=“nnn”) from the product information database 43 based on the product ID in the affili-link, and also recognizes the URL of the seller page of the access destination from the URL of the seller page (url=“***** . . . ”, in this example “def.jp/ghl.html”) in the affili-link. Further, the introducer of the product identifies the introducer (affiliate 2) of the product based on the affiliate ID (af=“***** . . . ”, in this example “abc”) in the affili-link, and extracts the information on the affiliate 2 from the affiliate information database 42.

Next, a second example of the affili-link will be described.

The information on the “URL of the seller page” is also included in the product information registered with the product information database 43 as described in “3. Registration processing of product information.” Consequently, the affili-link is realizable also in a following form.

### <Second Example of Affili-Link (Link for Navigation)>

http://www.xyz.jp/af.php?af=abc&item=nnn

(information after af= is the affiliate ID, and information after item= is the product ID)

Although the affili-link created by the navigation link creating means has been a form in which the URL of the seller page is included in the affili-link in the first example of the affili-link, the URL of the seller page is reproduced from the product information obtained from the product information database 43 based on the product ID or the sales ID in a second example. Incidentally, both examples may be employed, but the first example is more preferable in respect of processing speed or the like.

### <<5. Navigation Processing to Seller Page By Address Translation>>

Next, navigation processing to the seller page will be described.

A feature of the affiliate sales in the affiliate selling system in accordance with the present invention is once navigating the user to the seller page. With this navigation, it is possible to make up for lack of information at the time of displaying products in the normal shopping site, and aim at effects of encouraging the willingness to buy.

Accordingly, when the affili-link is clicked on the Web page (on the screen of the terminal of the purchaser 3) of the weblog and the mail magazine of the affiliate 2, the affiliate selling system 30 acquires the URL of the seller page in the affili-link, and translates the address of the access destination to the URL of the seller page address to thereby make the user jump to the seller page indicated by the URL.

### <<6. Purchase Link Set to Seller Page>>

Next, the purchase link set to the seller page will be described.

In the affiliate selling system 30, the navigation to the seller page is performed by the address translation to the URL of the seller page using the affili-link, but when it navigates to the seller page, the sale does not go through unless the user actually purchases products, so that the purchase link (refer to the aforementioned concrete example “www.xyz.jp/a.php?item=nnn”) is set to the seller page in advance. The purchaser 3 can purchase products by clicking this purchase link. In that case, since the introducer's affiliate ID generally disappears by going through the seller page, the present embodiment employs a system that the affiliate ID is once stored in the cookie by the affili-link, and when the purchase link is clicked, the introducer's affiliate ID is restored by reconstructing the affiliate ID, and thus the affiliate commission is generated for the introducer identified by the affiliate ID.

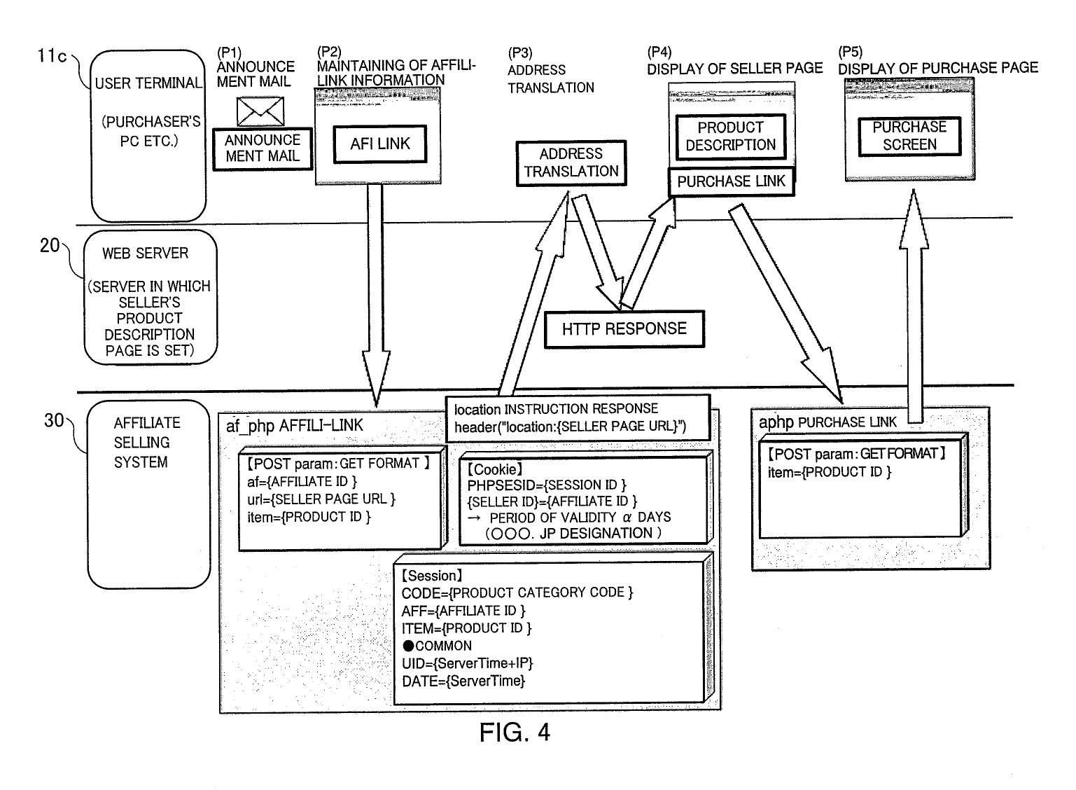

When a flow of the affiliate sales processing mentioned above is shown by a drawing, it will result in FIG. 4.

The operation example of the affiliate selling system in accordance with the present invention will be described hereinafter with reference to a schematic diagram shown in FIG. 4. Note that a Web server 20 in FIG. 4 is a server in which the seller's product description page is set, and the user terminal 11c is a communication terminal of the purchaser (general user). Additionally, symbols (P1) through (P5) in FIG. 4 show the flow of the processing, and arrows in FIG. 4 indicate information flows through the communication networks. Hereinafter, the flow of the affiliate sales processing will be described along with the flows of (P1) through (P5).

### (P1) Announcement Mail

An “announcement mail” mentioned here means a sales promotion mail distributed towards prospective customers in order for the affiliate 2 to notify of, introduce, and sell products. The affiliate selling system 30 sets the affili-link in sentences of the announcement mail to perform the purchase navigation. While the affili-link set here is the affili-link shown as the aforementioned first example or second example, the first example is employed in the example shown in FIG. 4. Hence, there is set the affili-link with a form in which (a1) the affiliate ID, (a2) the URL of the seller page, and (a3) the product ID are added to the end of the URL of the affiliate selling system 30, in the sentences of the announcement mail.

### (P2) Maintaining of Affili-Link Information

When the user clicks the affili-link (AFI link in FIG. 4) in the mail sentence currently displayed on the screen of the user terminal 11c (or on the Web pages of the weblog or the like), a cookie which has recorded the product ID (or the seller ID) and the affiliate ID on the user terminal 11c is set, and it is set so that this information may be reproduced till the period of validity (for example, 30 days from a setting day) of the cookie even when the browser is closed thereafter or a personal computer is turned off.

### (P3) Address Translation

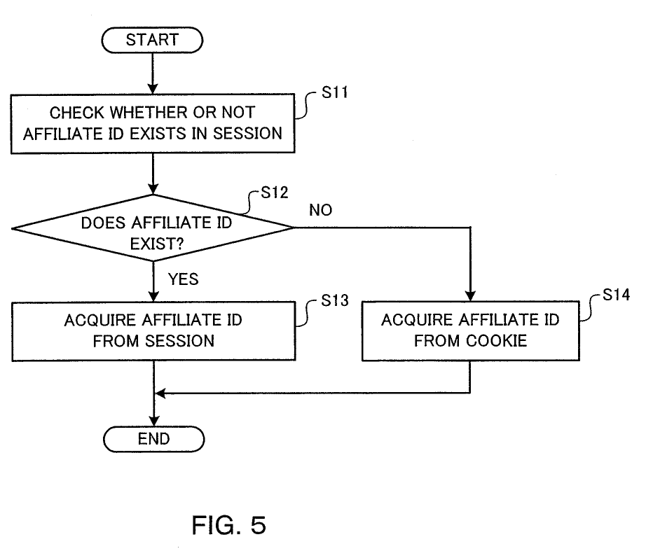

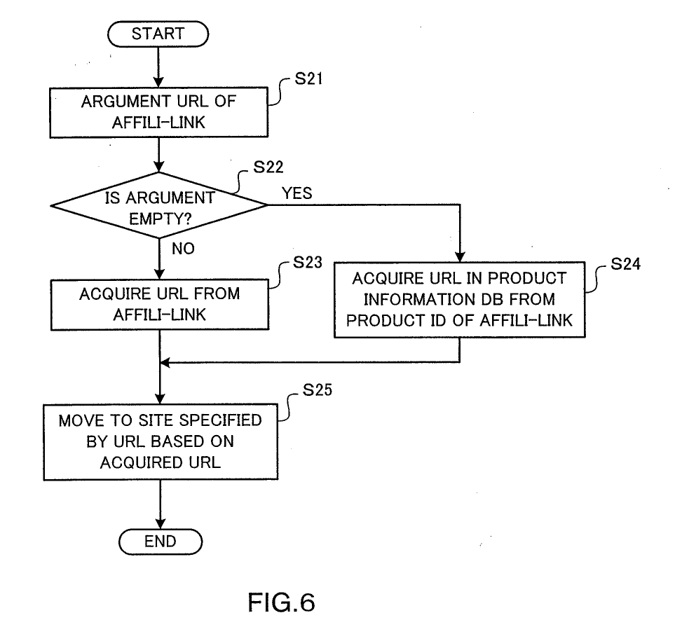

When the affili-link is clicked in above P2, the affiliate selling system 30 navigates the user to the Web site of the seller 1 by the address translation means of the access URL. The address translation processing of the URL by this address translation means will be described using flow charts shown in FIG. 5 and FIG. 6.

First, the acquisition processing of the affiliate ID will be described with reference to the flowchart shown in FIG. 5.

The affiliate selling system 30 analyzes the session information between it and the user terminals 11c to check whether or not the affiliate ID exists (Step S11), and determines the existence of the affiliate ID (Step S12). Subsequently, if it is determined that the affiliate ID exists, it acquires the affiliate ID from the session information (Step S13), whereas if it is determined that the affiliate ID does not exist, it reads contents of the cookie and acquires the affiliate ID from the cookie (Step S14).

The aforementioned logic is a logic for switching the cookie and the session upon moving from the affill-link to the product purchase as a method for acquiring the affiliate ID when acquiring and succeeding to the affiliate ID. For example, when the user directly moves from the affili-link to the product purchase without closing the browser, the session can exist, so that the affiliate ID is acquired from the session. Moreover, for example, when the URL of the seller page is once added to a “bookmark” or the like, and products are purchased afterwards, the personal computer is turned off, or the browser is once closed, so that the session is disconnected, and thus the session information does not exist anymore. In that case, the cookie which is set upon reading the affili-link is read and the affiliate ID is acquired.

Next, the address translation processing upon moving from the affili-link to the product purchase will be described with reference to the flow chart shown in FIG. 6.

The affiliate selling system 30 first acquires the argument URL in the affili-link (Step S21), and determines whether or not the argument URL is empty (Step S22). If it is determined that the argument URL is not empty, it acquires the URL of the seller page from the affili-link (Step S23), whereas if it is determined that the argument URL is empty, it acquires the URL of the seller page which is stored in association with the product ID (or seller ID) of the affill-link, from the product information database 43 (Step S24).

Subsequently, the address translation means navigates (jump), in response to a click operation of the affili-link, to a site specified by the URL of the seller page by translating the access destination URL of the user terminal 11c of the operation source from the URL of the affiliate selling system 30 to the URL of the seller page address. In the example of the aforementioned affili-link, it address-translates the URL from “http://www.xyz.jp” to “def.jp/ghi.html” to move to the URL of the seller page indicated by “def.jp/ghl.html.” At that time, setting of the page instantly displayed is set to the URL of the seller page using a redirection function (LOCATION instructions response) of HTTP (Hyper Text Transfer Protocol) (Step S25).

### (P4) Display of Seller Page

When moving (jumping) to the URL of the seller page, the seller page which is displayed and set by the address translation described above (P3) is displayed on the display unit of the user terminal 11c. In the seller page, it is possible to make up for lack of information and aim at effects of encouraging the willingness to buy by displaying the product information (aforementioned descriptions of products, photographs of the products, or the like) corresponding to the product ID as compared with a case of displaying the products in the normal shopping site. The user can purchase the product by clicking the purchase link on the seller page currently displayed on the display unit of the user terminal 11c.

### (P5) Display of Purchase Page

When the user clicks the purchase link of the seller page, the user will move to the affiliate selling system 30, screen data of a purchase page will be transmitted to the user terminal 11c by the affiliate selling system 30, and the screen of the purchase page will be displayed on the display unit of the user terminal 11c. If the user purchases products, the user selects a form of settlement (pay-by-card, bank transfer or the like) to purchase desired products.

Next, purchase patterns when the purchaser purchases products will be described.

When the purchase pattern is roughly classified, there are a pattern of downloading and purchasing contents (digital product) (hereinafter referred to as “first pattern”), a pattern of subscribing and registering to a paid mail magazine (hereinafter referred to as “second pattern”), and a pattern of purchasing goods (hereinafter referred to as “third pattern”).

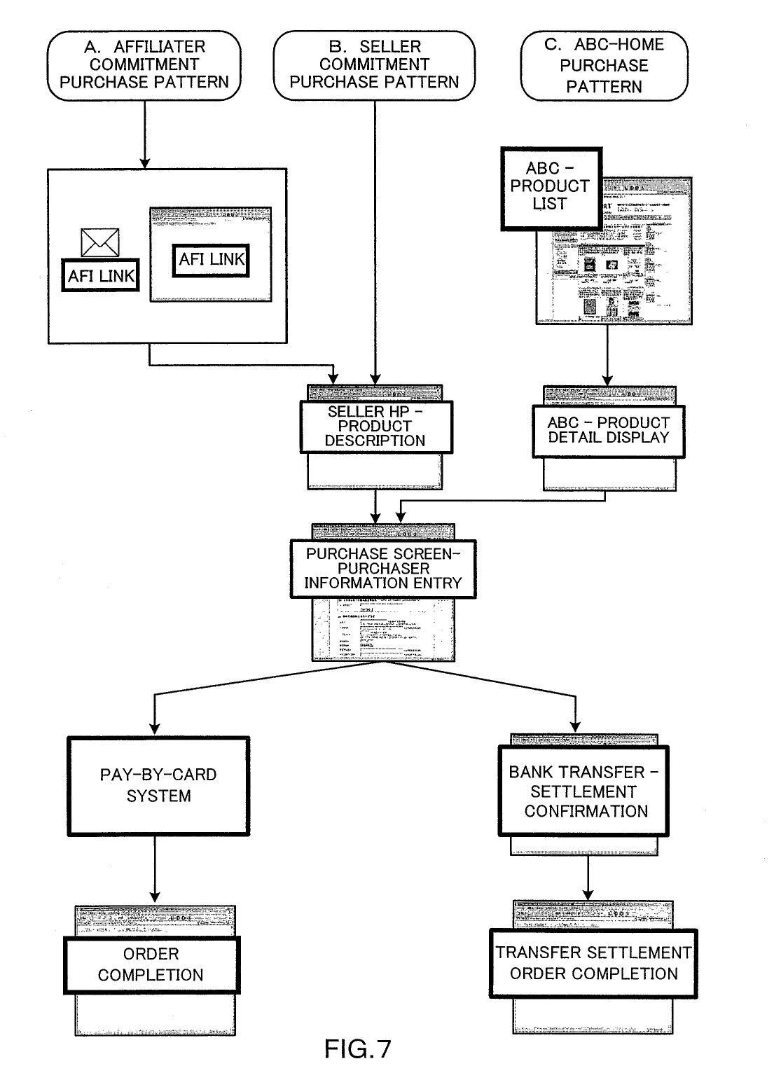

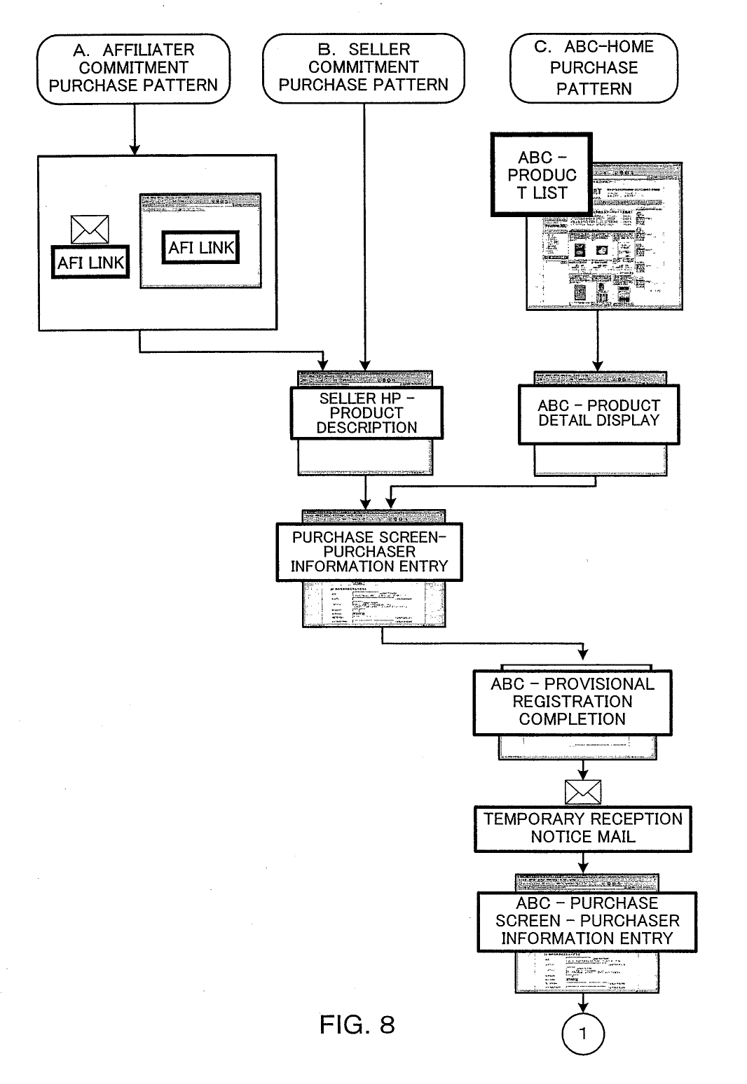

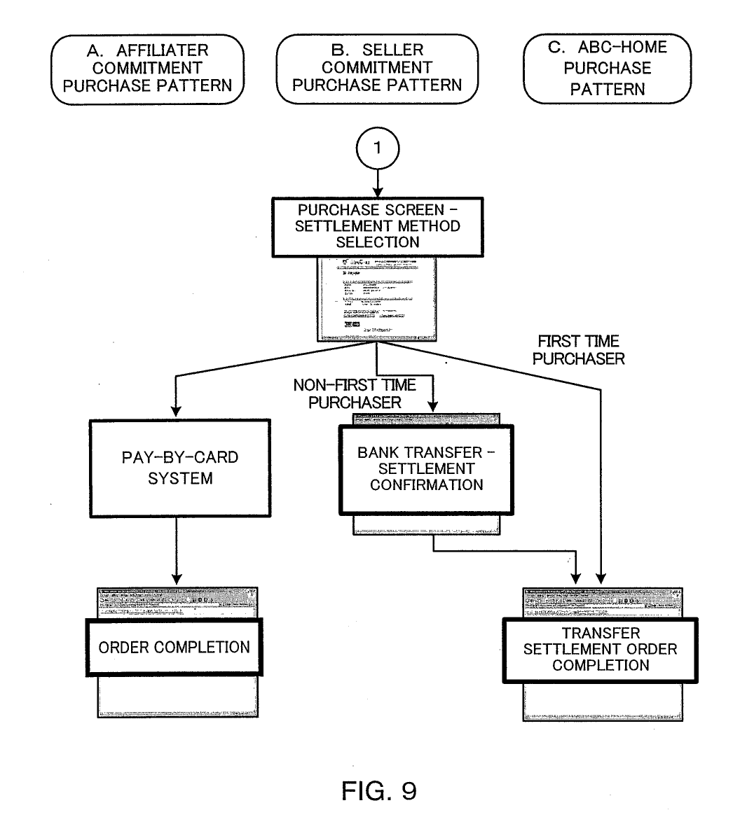

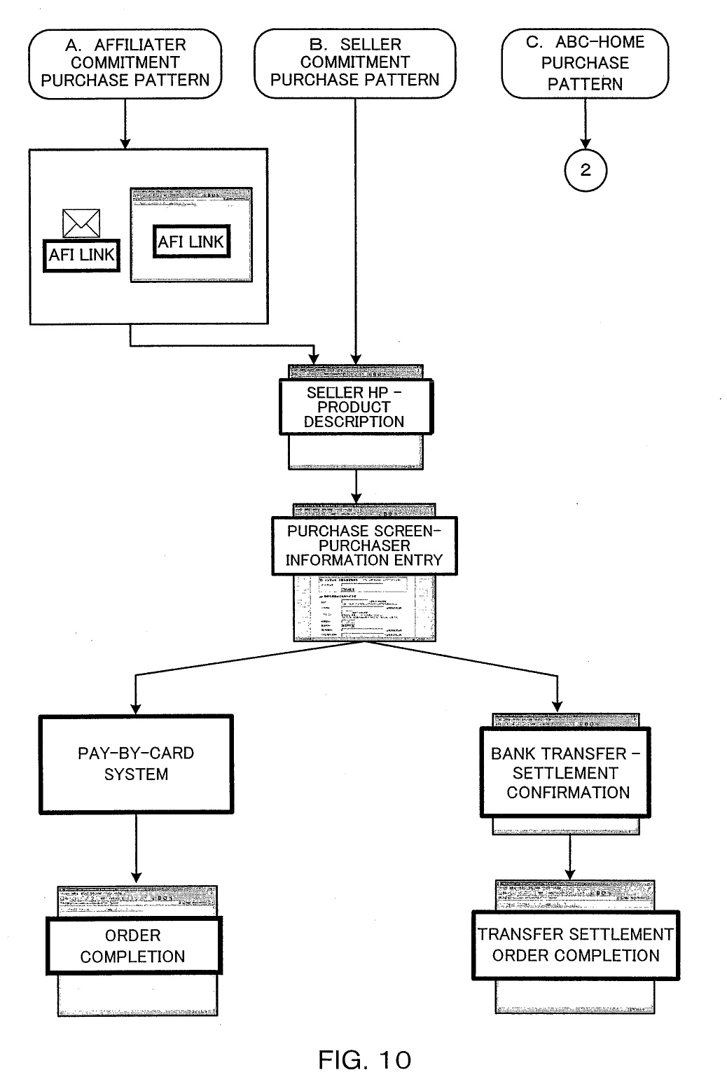

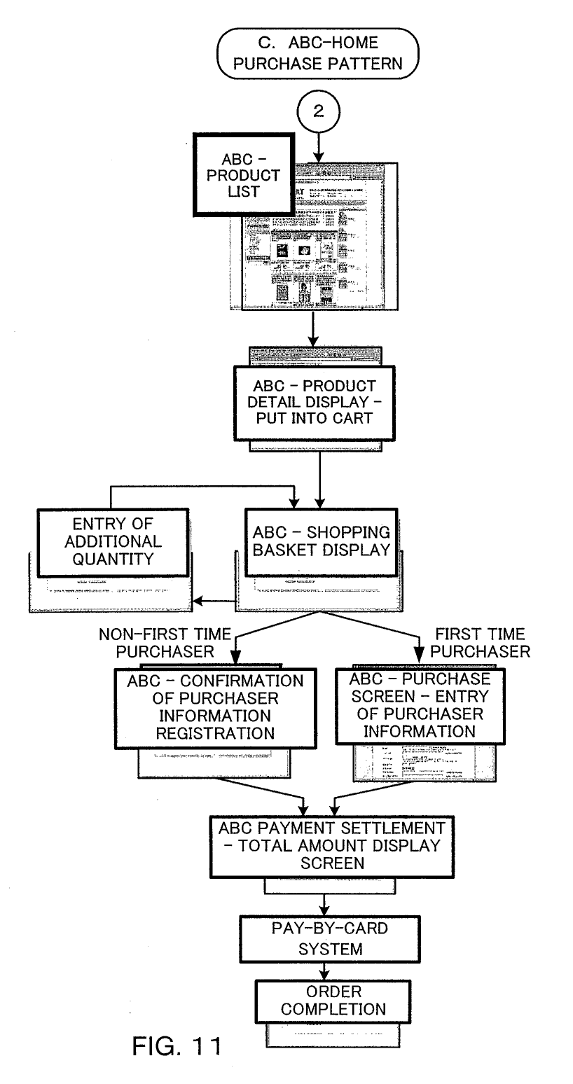

FIG. 7 is a schematic diagram showing an example of a screen change in the first purchase pattern of products, FIGS. 8 and 9 are schematic diagrams showing examples of the screen change in the first purchase pattern of products, and FIG. 10 and FIG. 11 are schematic diagrams showing example of the screen change in the first purchase pattern of products. Incidentally, as for the pattern of purchasing through a root of “A. Affiliate commitment” in these drawings, when an order is completed, the commission is will be paid to an affiliate considered to be a navigator. Additionally, as for the pattern of purchasing through a root from “B. Seller commitment”, when an order is completed, the commission is paid to a seller who has navigated. A root of “C. ABC. home” is a pattern of purchasing products published on the Web page of the affiliate selling system. The screen changes on the side of the user terminal in respective patterns are as shown in FIG. 7 through FIG. 11, and a description of each pattern will be omitted.

Even when either pattern may be employed, the aforementioned accounting processing and settlement processing are performed, and processing from the product purchase to the settlement is automatically performed in the affiliate selling system 30. Moreover, the aforementioned address translation processing is also performed similarly even when either pattern may be employed.

Note herein that although a mode in which information including the affiliate ID or the like is set to and stored in the cookie, and when the session is disconnected, the introducer' s affiliate ID is reconstructed from the cookie has been described as an example in the embodiment mentioned above, it may be a mode in which the information is stored in the database of the affiliate selling system 30. Accordingly, it may be a mode that information in which the product ID or the seller ID for identifying the seller, and the affiliate ID are recorded is stored in an information storage medium in response to a click operation of the affili-link currently displayed on the screen of the user terminal. A system independent of the type of the client terminal can be achieved by employing this mode. Moreover, as a result of this, troubles due to a difference in cookie implementation for every browser and problems of restriction of the cookie that only up to 20 cookies could not be used (a maximum number of cookies for every server or domain) are avoidable.

What is claimed is:

1. An affiliate selling system provided with a server having a function for navigating to a seller page which is a Web page of a seller of products based on a link for navigation pasted on a page of the products introduced on a mail magazine or a weblog by affiliates, the server comprising:
navigation link creating means for creating, using an affiliate ID for identifying the affiliate and a product ID for identifying the product as an argument URL, URL information in which the argument URL is added to a URL of the affiliate selling system as a link for navigation; and
address translation means for address-translating, in response to a click operation of the link for navigation, an access destination URL of a user terminal of the operation source from the URL of the affiliate selling system to a URL of the seller page.

2. The affiliate selling system according to claim 1, wherein the navigation link creating means creates the link for navigation while including the URL of the seller page in the argument URL.

3. The affiliate selling system according to claim 2, wherein the address translation means acquires the argument URL within the link for navigation and also acquires the URL of the seller page included in the argument URL, and performs the address translation processing based on the URL.

4. The affiliate selling system according to claim 1, comprising a product information database in which product information including descriptions of products for sale and the URL of the seller page is stored, wherein when the URL of the seller page does not exist within the link for navigation, the address translation means acquires the URL of the seller page, which is stored in association with the product ID or a seller ID for identifying a seller, from the product information database, and performs the address translation processing based on the URL.

5. The affiliate selling system according to claim 1, wherein the server further comprises means for setting, in response to a click operation of the link for navigation which is displayed on a screen of a user terminal, a cookie on which the product ID or the seller ID for identifying the seller, and the affiliate ID are recorded to the user terminal.

6. The affiliate selling system according to claim 1, wherein the server further comprises means for analyzing session information between the server and a user terminal to check whether or not the affiliate ID exists, and then acquiring the affiliate ID from the session information if it is determined that the affiliate ID exists, or reading the contents of the cookie to acquire the affiliate ID from the cookie if it is determined that the affiliate ID does not exist.

7. The affiliate selling system according to claim 1, wherein the server further comprises means for storing, in response to a click operation of the link for navigation which is displayed on a screen of a user terminal, information in which the product ID or the seller ID for identifying the seller, and the affiliate ID are recorded in an information storage medium.

8. The affiliate selling system according to claim 1, wherein the server further comprises settlement means for automatically determining commission to be paid to the affiliate to automatically transfer it to an account of the affiliate.
